(19) United States
(12) Patent Application Publication
(10) Pub. No.: US 2017/0249331 A1
(43) Pub. Date: Aug. 31, 2017

(54) ADAPTING TO HETEROGENEOUS BACKEND TARGETS IN A STORAGE SYSTEM

(71) Applicant: NetApp, Inc., Sunnyvale, CA (US)

(72) Inventors: Ghassan Abdallah Yammine, Leander, TX (US); Derek William Beard, Austin, TX (US); Garret Lance Hayes, Austin, TX (US); Bryan Matthew Venteicher, Austin, TX (US)

(21) Appl. No.: 15/053,904

(22) Filed: Feb. 25, 2016

(51) Int. Cl. G06F 17/30

(52) U.S. Cl. CPC G06F 17/30203; G06F 17/30233; G06F 17/30091

(57) ABSTRACT

A system has been designed that uses defined, abstracted object commands to facilitate adaptation to heterogeneous backend targets. The backend targets are heterogeneous at least in terms of data access protocols. The architecture of the system allows the system to adapt to changes in data access protocols and addition of data access protocols. The system can operate as a bridge between multiple instances of multiple file systems and the heterogeneous backend targets. The system directs the abstracted object commands to an object storage adapter. The object storage adapter is designed to route a defined, abstracted object command to at least one of a number of modules that translate the abstracted object command.

### BACKGROUND

The disclosure generally relates to the field of data storage, and more particularly to adapting abstracted store commands to target implementations.

Many cloud storage solutions have adopted object storage as the cloud storage paradigm. Object storage is an abstraction that is independent of the underlying storage hardware and storage software. An account is associated with a logical container (e.g., a bucket), and the logical container contains variable sized objects in accordance with the configuration of the logical container. For instance, the container configuration can establish a maximum size of the container, unlimited object size, etc. Each object can hold data and metadata.

The objects in object storage can be accessed with a web based service. The web based service may comport with the simple object access protocol (SOAP), the Representational State Transfer (REST) architecture, etc. For instance, objects in object storage can be accessed with requests defined by the Hypertext Transfer Protocol (HTTP) in accordance with the REST architecture. This allows scalability and access that is independent of location.

Although object storage offers scalability and flexibility, many deployed applications and/or systems have already been created to interact with a file system. Thus, these legacy applications/systems use a particular file system interface, such as the Portable Operating System Interface (POSIX) to access data. Legacy applications/systems can also use any one of a variety of file-based network protocols (e.g., server message block/Common Internet Filesystem (SMB/CIFS), the network file system (NFS) protocol, the file transfer protocol (FTP), etc.).

### BRIEF DESCRIPTION OF THE DRAWINGS

Aspects of the disclosure may be better understood by referencing the accompanying drawings.

FIG. 1 depicts an environment with an adaptable bridge between a file system client and heterogeneous backend targets.

FIG. 2 depicts a flowchart of example operations for starting an object adapter.

FIG. 3 depicts a flowchart of example operations converting an abstracted object command into a target protocol implementation.

FIG. 4 depicts a flowchart of example operations for processing a backend target response to be conveyed back to a client.

FIG. 5 depicts an example computer system with an object store adapter.

### DESCRIPTION

The description that follows includes example systems, methods, techniques, and program flows that embody aspects of the disclosure. However, it is understood that this disclosure may be practiced without these specific details. For instance, the example illustrations refer to network attached storage (NAS) data access protocols, but embodiments can abstract and adapt commands from other protocols (e.g., storage area network (SAN) data access protocols). Well-known instruction instances, protocols, structures and techniques have not been shown in detail in order not to obfuscate the description.

Overview

A system has been designed that uses defined, abstracted object commands to facilitate adaptation to heterogeneous backend targets. The backend targets are heterogeneous at least in terms of data access protocols (e.g., different object storage protocols, file-based protocols, etc.). The architecture of the system allows the system to adapt to changes in data access protocols and addition of data access protocols. The system can operate as a bridge between multiple instances of multiple file systems and the heterogeneous backend targets. The system directs the abstracted object commands to an object storage adapter. The object storage adapter is designed to route a defined, abstracted object command to at least one of a number of modules that translate the abstracted object command. The object storage adapter routes an abstracted object command according to configuration of a file system instance. A module translates the abstracted object command into a set of one or more commands/calls/requests (hereinafter “backend commands”) tailored and/or optimized for a particular data access protocol implementation of the corresponding backend target (“target protocol implementation”). Examples of target protocol implementations include a particular implementation of an object storage protocol, an extension of an object storage protocol, and a file-based protocol.

Example Illustrations

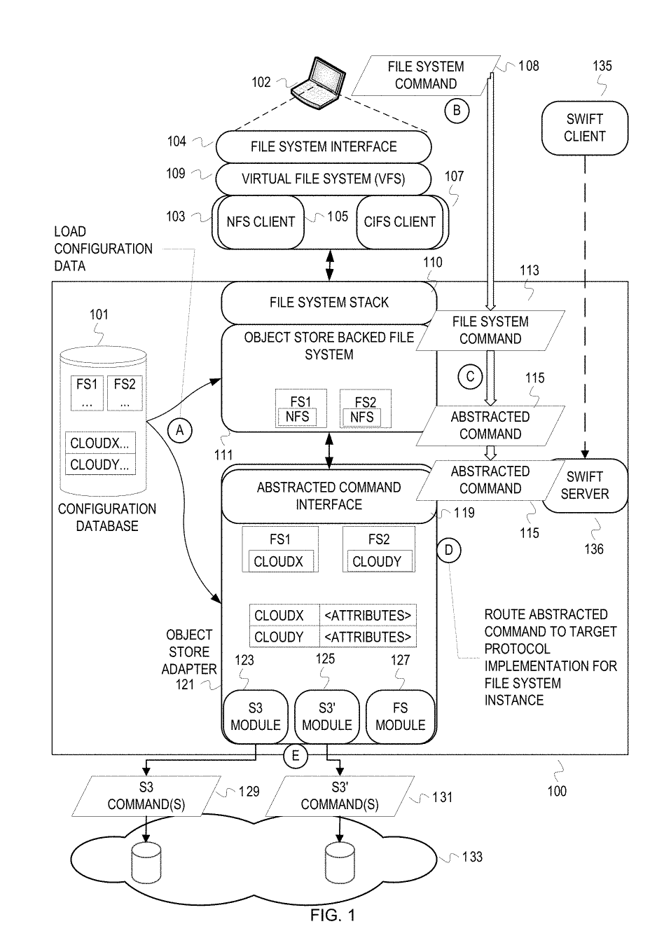

FIG. 1 depicts an environment with an adaptable bridge between a file system client and heterogeneous backend targets. The depicted environment includes a bridge device 100 and a client device 102. These devices communicate over a network that is not depicted. Data input into the client device 102 flow through the bridge device 100 to backend targets 133. For this illustration, the backend targets 133 are object storage maintained by a cloud service provider. The client device 102 presents a file system instance(s) to users and allows manipulation of the file system instance according to a network attached storage protocol in this example illustration. Regardless of what is presented at the client device 102, the underlying hardware/software that maintains the data (“backend”) can vary.

FIG. 1 depicts a few example protocols to aid in understanding the disclosure, and the examples should not be used to limit the claims. In FIG. 1, NAS protocol implementations 103 are installed at the client device 102. These example protocol implementations 103 include a network file system (NFS) client 105 and a Common Internet File System (CIFS) client 107. After a file system command is submitted to a file system interface 104 or a system call is made, the command is converted into a virtual file system command by a virtual file system (VFS) 109. The VFS 109 then passes the virtual file system command to one of the network attached storage (NAS) protocols 103 for conversion to the particular file-based network protocol. For the example backend targets 133, one of the object storage targets accepts Simple Storage Service (S3) commands and the other object target accepts an extension of the S3 commands (S3′).

The bridge device 100 becomes aware of the backend targets 133 when an administrator initially configures the bridge device 100. Initial configuration exposes the backend targets to the bridge device 100. An administrator will initially create configuration data in a configuration database 101. Examples of the configuration data include a logical container identifier (e.g., an object storage account identifier, a logical container name), backend target credentials for accessing the backend targets, network addresses for the backend targets, etc. In this example illustration, the configuration database 101 includes configuration data for accounts CLOUDX and CLOUDY. After configuration of a backend target, an administrator can configure one or more file system instances. The configuration database 101 also includes the configuration data for the file system instances. The configuration data for a file system instance at least includes an identifier for the file system instance, an already configured backend target, and indication of a data access protocol for the file system instance. This data access protocol will be how users interact with the file system instance. File system instance configuration data can also include a mount point, namespace identifier if not the same as the file system instance identifier, permissions, etc. The configuration database 101 includes configuration data for file system instances FS1 and FS2. Due to sheet size constraint, FIG. 1 depicts ellipsis to represent the various configuration data for the accounts CLOUDX and CLOUDY, and the file system instances FS1 and FS2.

FIG. 1 is annotated with a series of letters A-E. These letters represent stages of one or more operations that can occur after a backend target and file system instance have been configured. Although these stages are ordered for this example, the stages illustrate one example to aid in understanding this disclosure and should not be used to limit the claims. In addition to the stages, a file system command that flows through the system is illustrated in parallel with the system components to depict transformation of the command. Subject matter falling within the scope of the claims can vary with respect to the order and some of the operations.

At stage A, the bridge device 100 drives configuration data from the configuration database 101. At start up, the bridge device 100 will execute program code for an object store adapter (“OSA”) 121 and program code for an object store backed file system (“OSFS”) 111. For example, the bridge device 100 can launch the OSA as a service on the bridge. When starting, the OSFS 111 and the OSA 121 read the configuration database 101 for the configuration data. For each file system instance configuration, the OSFS 111 and the OSA 121 each creates a file system object instance. The OSFS 111 instantiates a file system object for FS1 with the FS1 configuration and a file system object for FS2 with the FS2 configuration. For this illustration, both FS1 and FS2 have been configured as NFS file system instances. So, the FS1 and FS2 object instances indicate the NFS data access protocol. The OSA 121 also instantiates file system objects for FS1 and FS2. But the FS1 and FS2 file system object instances in the OSA 121 context at least indicate the file system instance identifiers and backend targets. FS1 was previously bound to the backend target CLOUDX and FS2 was previously bound to the backend target CLOUDY.

At stage B, a file system command 108 is submitted at the client device 102. The path of the file system command 108 includes the NFS client 103 and the VFS 109. For this example, the NFS client 105 sends an NFS command to a file system stack 110. FIG. 1 depicts the file system stack 110 instead of the individual components to avoid unnecessarily complicating the figure. The file system stack 110 includes NAS servers, such as an NFS server, and a virtual file system instance. In the file system stack, the NFS server passes the NFS command to the VFS instance converts the NFS command into a VFS file system command 113 (“file system command”), which is provided to the OSFS 111.

At stage C, the OSFS 111 translates the file system command 113 into an abstracted object command (“abstracted command”) 115. The OSFS 111 parses the file system command 113 to determine the corresponding file system instance. The OSFS 111 may extract a particular field or examine a pathname in the file system command 113 to determine the corresponding file system instance. If the file system command 113 corresponds to the file system instance FS1, then the OSFS 111 uses the FS1 object instance to determine that the file system command 113 is to be translated from an NFS command to the abstracted command 115. If the file system command 113 corresponds to the file system instance FS2, then the OSFS 111 uses the FS2 object instance to determine that the file system command 113 is to be translated from a file system command to the abstracted command 115. An identifier of the file system instance propagates from the file system command 113 to the abstracted command 115.

At stage D, the OSA 121 routes the abstracted command 115 to a module based on target protocol implementation for the file system instance corresponding to the abstracted command 115. The OSA 121 receives the abstracted command 115 via an abstracted command interface 119. The OSA 121 examines the abstracted command 115 to identify a file system instance. After identifying the file system instance from the abstracted command 115, the OSA 121 selects a file object instance based on the identified file system instance. If the abstracted command 115 includes an identifier for FS1, then the OSA 121 accesses the object instance for FS1 and determines that FS1 is bound to CLOUDX. The OSA 121 then accesses the information about CLOUDX and determines that the attributes for CLOUDX indicate the S3 protocol. The OSA 121 routes the abstracted command 115 to an S3 module 123. With the S3 module 123, the OSA 121 determines an optimized S3 command(s) 129 for carrying out the abstracted command 115. The OSA 121 transmits the S3 command(s) 129 to the backend target identified for CLOUDX in the backend targets 133. If the abstracted command 115 includes an identifier for FS2, then the OSA 121 accesses the object instance for FS2 and determines that FS2 is bound to CLOUDY. The OSA 121 then accesses the information about CLOUDY and determines that the attributes for CLOUDY indicate the S3′ protocol. The OSA 121 routes the abstracted command 115 to an S3′ module 125. With the module 125, the OSA 121 determines an optimized S3′ command(s) 131 for carrying out the abstracted command 115. The OSA 121 transmits the S3′ command(s) 131 to the backend target identified for CLOUDY.

Other backend targets are possible and need not be cloud service provider maintained object store targets. A FS module 127 could be loaded into the OSA 121 if a file system instance is configured to be bound to a backend target that implements a file-based protocol. For example, the Microsoft® Azure platform provides a file storage service via SMB. The OSA 121 could convert an abstracted command that started as a NAS type of command into an SMB message for a backend target on an Azure platform.

In addition, embodiments are not limited to initially accepting a file-based network protocol command that is translated into an abstracted command. A Swift client 135 can submit a Swift defined command to a Swift server 136 hosted at the bridge device 100. The Swift server 136 converts the Swift defined command into an abstracted command and provides the abstracted command to the abstracted command interface 119.

Below are examples of abstracted commands that can be exposed by the OSA to upstream components. Following the abstracted commands are examples of object storage protocol implementations of the abstracted commands.

Abstracted Object Commands

listObjects (ID: Long, prefix: String, marker: Option[String]): Provided a file system instance identifier (“ID”), a prefix string and an optional last offset marker string, return a list of object identifiers that begin with the provided prefix. If the marker is provided, start with the marker, otherwise, start from the first key.

createObject (ID: Long, key: String, metadata: Map[String, String]): Provided an file system instance ID, a key string, and a map of metadata to persist, create a new object in the backend target of the identified file system instance with the provided key. Create the object with the provided user metadata that is contained in the map. If the object already exists, update its metadata.

deleteObject (ID: Long, key: String): Provided a file system instance ID and a key string, delete the object associated with the key in the backend target of the identified file system instance.

readObjectMetadata (ID: Long, key: String): Provided a file system instance ID and a key string, return the object's user metadata as a map of string key/value pairs.

writeObjectMetadata (id: Long, key: String, metadata: Map[String, String]): Provided a file system instance ID, a key string, and a metadata map, overwrite the object's metadata with the new provided metadata.

writeObjectData (id: Long, key: String, metadata: Map[String, String], extents: Seq[dataExtents]: Provided a file system instance ID, a key string, a map of new metadata, and a sequence of data extents, write those data extents to the object data and update the object's metadata with the provided map.

readObjectData (id: Long, key: String, extents: Seq[DataExtents]): Provided a file system instance ID, a key string, and a set of requested data extents, return the data from the object identified by the key, along with the objects current metadata.

truncateObject (id: Long, key: String, size: Long, metaData: Map[String, String]): Provided a file system instance ID, a key string, a new (shorter) size, and new metadata, shrink the object such that its new size reflects the size specified in the request. Also, persist the new user metadata on the object.

Example OSA Target Protocol Implementation of Abstracted Object Commands

The below examples first identify the abstracted command and then how the abstracted command is converted into an object store target implementation of the command. For these example conversions, the OSA replaces the file system instance ID with an identifier relevant to the backend target, which would be defined in the configuration data. This could be an account identifier, logical container identifier, another file system instance identifier, etc. For instance, a file system instance identifier is replaced with an identifier of a logical container of the object store account bound to the file system instance ID. The OSA determines the logical container identifier from the attributes of the backend target bound to the file system instance, as previously discussed. For the keys, the OSA may maintain data that bi-directionally maps a file handle or filename (hereinafter “filename”) to an object key. When creating the target protocol implementation of an abstracted command, the OSA can lookup the object key and use the object key from the mapping data. The OSA may use a same value for both filename and the object key. In some implementations, the OSA may use a transform function between a filename and an object key (e.g., transform a string filename into an integer value to be used as the object key).

listObjects (ID: Long, prefix: String, marker: Option[String]): The OSA converts listObject to call to ‘GET Bucket (List Objects)’. This conversion is effectively complete after the OSA determines the logical container identifier from the file system instance identifier.

createObject (ID: Long, key: String, metadata: Map[String, String]): The OSA converts createObject to a ‘PUT Object’, attaching the passed user metadata to the new object in the PUT request call.

deleteObject (ID: Long, key: String): The OSA converts deleteObject to a call to ‘DELETE object’, deleting the object specified by the requested key.

readObjectMetadata (ID: Long, key: String): The OSA converts readObjectMetadata to ‘HEAD Object’. HEAD Object will return the user metadata associated with the requested key.

writeObjectMetadata (id: Long, key: String, metadata: Map[String, String]): The OSA converts writeObjectMetadata to either a ‘PUT Object-Copy’ or a ‘Multi-part Object -Copy’ depending upon the size of the existing object. If the object's current size is below a target protocol implementation defined multipart minimum (e.g., 5 gigabytes), then PUT Object-Copy' is used. Otherwise, the OSA uses the ‘Multi-part Object-Copy’. In either scenario, the copy is initiated with the key for the source and destination, corresponding to the requested key. The requested metadata is persisted to the new copy of the object and the object's data is unchanged.

writeObjectData (id: Long, key: String, metadata: Map[String, String], extents: Seq[dataExtents]: The OSA evaluates the arguments of writeObjectData to determine an appropriate conversion. First, the OSA sorts the provided extents by offset and validates the extents to ensure that they don't exceed the size of the object. If the current object is empty, then either a ‘PUT Object’ or ‘Multi-part Upload’ is used to overwrite the entire object with its new data. The choice between PUT Object and Multi-part is based upon the target protocol implementation defined limit for Multi-part uploads. If the current object is not empty, then a ‘Multi-part copy’ operation is performed. This multi-part copy creates a multiple request transaction, consisting of a series of ‘parts’ where each part represents a portion of data to persist as object data. Each part may reference existing data within the current object or new data uploaded from the OSA. In this way, the OSA can merge together new data provided in a writeObjectData command into an existing object, and avoid downloading the existing object data to the OSA. Instead, the OSA confines itself to uploading modified data

readObjectData (id: Long, key: String, extents: Seq[DataExtents]): The OSA converts readObjectData to a ‘GET Object’ request, retrieving the data associated with the request's offset and length. The OSA determines the offset and length from the extents argument of the abstracted command. The OSA then writes the retrieved data to a filename provided with the request for efficient data transfer back to the calling service (e.g., the OSFS) or client.

truncateObject (id: Long, key: String, size: Long, metaData: Map[String, String]): The OSA converts a truncateObject depending upon the size argument. If the abstracted command indicates a size of 0, then the OSA converts truncateObject to a ‘PUT Object’, creating an empty object with the metadata provided in the request. If the abstracted command indicates a new size greater than 0, the OSA converts the truncateObject to a ‘Multi-part Copy’ request where the existing data up until the new size is copied back to the same object and the object's new size is the size from the truncate request. The new user metadata is also persisted with the object. This conversion, similar to the writeObjectData conversion, allows the OSA to avoid downloading the existing object data.

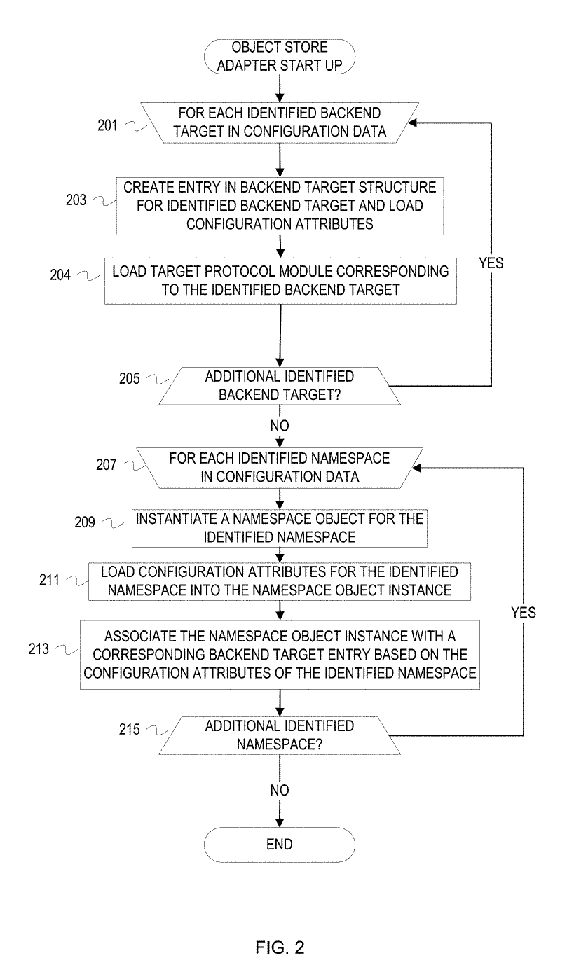

FIGS. 2-4 depict flowcharts to further aid in understanding the disclosure. The flowcharts refer to a dataset namespace or simply namespace instead of a file system instance. A namespace includes the set of symbols used to identify a set of objects and access those objects by those symbols. In the context of a file system, the symbols are the file names and pathnames to the files. In the context of object storage, the symbols are object keys and the name of the corresponding logical container (e.g., bucket).

FIG. 2 depicts a flowchart of example operations for starting an object store adapter. As part of starting up or instantiating an OSA, configuration data is loaded to establish a connection or path from a namespace to a backend target, as well as the related protocols. FIG. 2 refers to an OSA as performing the operations after OSA program code is invoked.

At block 201, the OSA begins to traverse configuration data to populate a backend target structure with data for each backend target identified in the configuration data. The configuration data may be in a store or database that is stored separately from the OSA. Regardless of where the configuration data is stored and maintained, the configuration data is stored and maintained in a persistent storage. An administrator can configure the OSA with location of the configuration data or the configuration data can be placed in a defined location. For each identified backend target, the OSA performs the operations depicted at blocks 203 and 204.

At block 203, the OSA creates an entry in the backend target structure for the identified backend target. The OSA can index the entry by an identifier of the backend target (e.g., network address, account name, etc.). The OSA also loads configuration attributes of the backend target into the structure at the created entry. For example, the OSA writes login credentials, protocol identifier, etc. into the structure entry.

At block 204, the OSA loads a target protocol module corresponding to the identified backend target. The OSA can search a repository of modules for a module with a name that corresponds to a protocol of identified backend target. For example, the OSA may search a repository for a module that includes ‘Swift” in the name. The OSA may access a directory of modules that are indexed by protocol identifiers. Loading the target protocol module may vary depending upon implementation. The OSA may load the target protocol module into a low latency memory or mark the module as active. The OSA may write an identifier of the target protocol module into the backend target structure.

At block 205, the OSA determines whether the configuration data includes another identified backend target. This determination may be made by encountering an end of file or end of list symbol or marker. Metadata can indicate that the configuration data identifies x backend targets. If there is an additional identified backend target in the configuration data, then control flows back to block 201. Otherwise, control continues to block 207.

At block 207, the OSA determines each identified namespace in the configuration data. The configuration data that identifies a namespace may be different configuration data than the configuration data that indicated the backend targets. The OSA performs operations represented by blocks 209, 211, and 213 for each of the identified namespaces.

At block 209, the OSA instantiates a namespace object for the identified namespace. A namespace object is defined to indicate information that identifies a namespace and associates it with a backend target. For example, a namespace object can be defined with fields/elements to identify a namespace (e.g., mount point and path), the protocol of the namespace (e.g., a file-based protocol), and the backend target bound to the namespace.

At block 211, the OSA loads the configuration attributes for the identified namespace into the namespace object instance. The OSA populates the fields/elements of the namespace object instance based on the configuration attributes.

At block 213, the OSA associates the namespace object instance with a corresponding backend target entry. The association is based on the configuration attributes of the identified namespace. For example, a configuration attribute in the configuration data identifies which backend target is bound to the identified namespace. The OSA can add this information to the namespace object instance and/or add a pointer to the corresponding entry in the backend target structure.

At block 215, the OSA determines whether the configuration data includes another identified namespace. This determination may be made by encountering an end of file or end of list symbol or marker. Metadata can indicate that the configuration data identifies x namespaces. If there is an additional identified namespace in the configuration data, then control flows back to block 207. Otherwise, the process ends

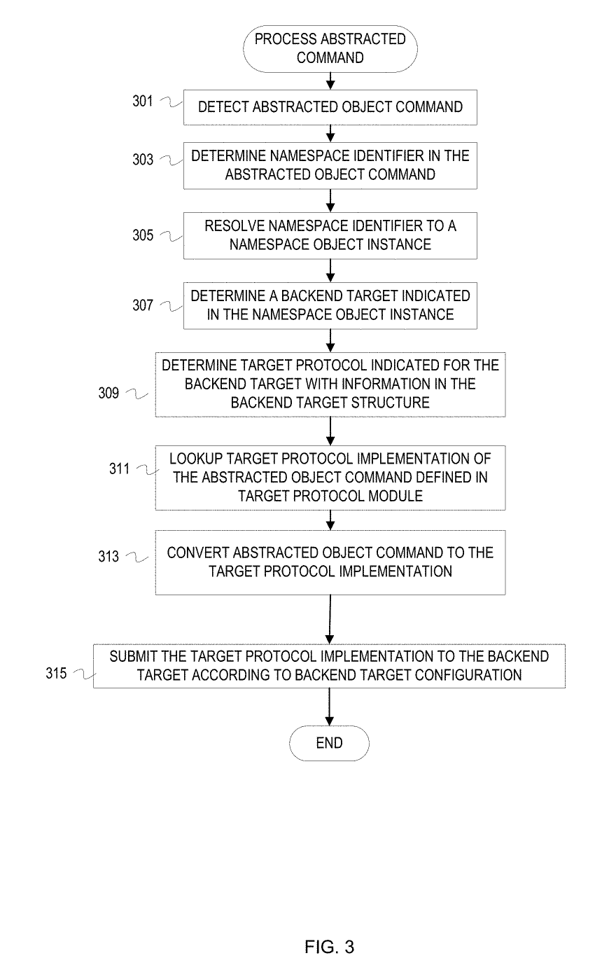

FIG. 3 depicts a flowchart of example operations converting an abstracted object command into a target protocol implementation. FIG. 3 refers to the OSA as performing the operations based on the instantiated namespace objects established in FIG. 2.

At block 301, the OSA detects an abstracted object command. The OSA can detect an abstracted object command with different techniques depending upon implementation. For instance, if the OSA is running as a system service, an upstream component (e.g., OSFS) can call the service by passing the abstracted object command in a service call. The OSA could receive the abstracted object command as a message via inter-process communications or a client server messaging system (e.g., Finagle network stack).

At block 303, the OSA determines a namespace identifier from the abstracted object command. The OSA parses the arguments of the abstracted object commend to obtain the namespace identifier. The abstracted object commands are predefined, so the OSA is already aware of what arguments are indicated in the abstracted object command and order thereof.

At block 305, the OSA resolves the namespace identifier to a namespace object instance. Since there can be many instances of many namespaces, the OSA selects from the instantiated namespace objects based on the namespace identifier. As examples, the namespace object instances can include a field/element for the namespace identifier or the identifiers of the namespace object instances may be derived from or be the namespace identifier.

At block 307, the OSA determines a backend target indicated in the namespace object instance. After selecting the corresponding namespace object instance, the OSA determines which backend target is identified in the namespace object instance.

At block 309, the OSA determines a target protocol indicated for the backend target for the identified namespace. The OSA looks up this information about target protocol in the backend target structure based on the identification of the backend target in the namespace object instance.

At block 311, the OSA looks up the target protocol implementation of the abstracted object command defined in a corresponding target protocol module. After the OSA determines the target protocol of the backend target for the identified namespace, the OSA selects the corresponding protocol module. The protocol module will indicate how to convert each of the abstracted object commands into implementations for the backend target protocol.

At block 313, the OSA converts the abstracted object command into the backend target protocol implementation of the abstracted object command. The OSA will convert or transfer arguments of the abstracted object command to the target protocol implementation of the abstracted object command. As already discussed, the conversion may be a 1:n mapping (i.e., 1 abstracted object command converts to a set of target protocol commands).

At block 315, the OSA submits the target protocol implementation to the backend target. This submission may be a single communication or multiple communications. The submission may be synchronous or asynchronous communications with the backend target. The backend target can be local or remote with respect to the OSA.

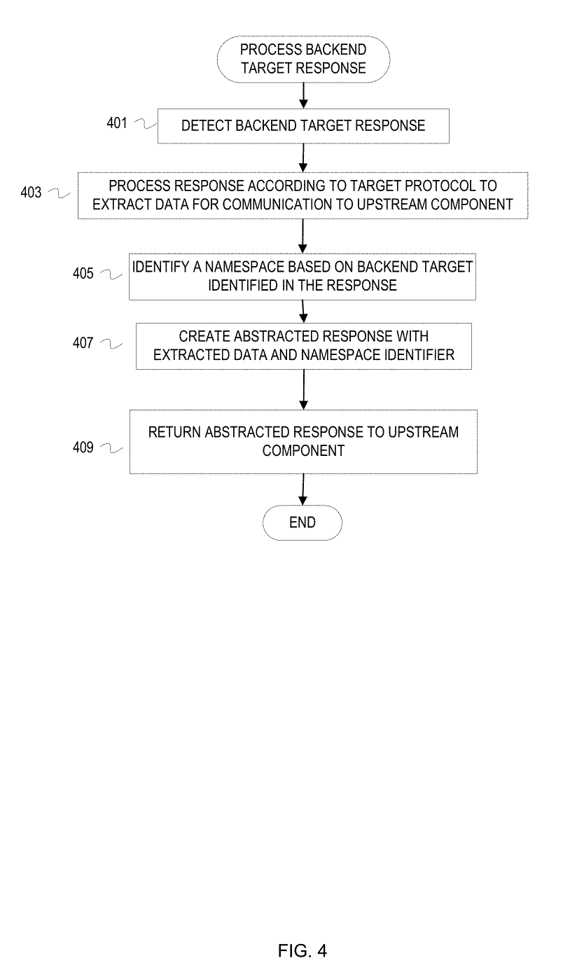

FIG. 4 depicts a flowchart of example operations for processing a backend target response to be conveyed back to a client. Some responses will be acknowledgements that a request/command was completed successfully or a notification that the request/command failed. Retrieval type of commands (e.g., reads) will return data. These different responses are reformed from a target protocol response into a response that complies with the protocol of the corresponding namespace (“namespace protocol”). FIG. 4 refers to the OSA as performing the example operations as in the previous example illustrations. For FIG. 4, however, the OSA has the capability to translate a response into an abstracted response. This is noted because FIG. 1 depicts this translating capability as a function of the OSFS.

At block 401, the OSA detects a backend target response. The OSA will leverage the communication mechanism of a backend target protocol to initially process a response from a backend target. For instance, when the OSA uses a backend target protocol implementation module to convert an abstracted a command, the OSA may instantiate a process that listens for a response, assuming a synchronous communication mechanism. As another example, the OSA can examine metadata of each backend target response to determine the corresponding protocol implementation and then invoke the corresponding target protocol module (e.g., a library file) to initially process the response. As another example, the conversion of an abstracted command into a target protocol implementation of the abstracted command may spawn a process that is bound to a logical port. A response will be received at the logical port to trigger initial processing by the process.

At block 403, the OSA processes the backend target response according to the target protocol to extract data for communication to an upstream component. The OSA can invoke program code defined in the backend target protocol module or an already spawned process will process the backend target response. In some embodiments, the OSA can access information that specifies how a response for a particular target protocol implementation is formatted (e.g., a locally maintained or remotely accessible definition of a well formed message for the target protocol). The OSA can then parse the response and extract the relevant data (e.g., logical container identifier, object identifier, success or failure of command, retrieved data, etc.).

At block 405, the OSA identifies a namespace based on the backend target identified in the response. If not already extracted in 403, the OSA will parse the response to determine the backend target that provided the response. The OSA can identify the namespace associated with the backend target. In some cases, the OSA will use both the logical container indicated in the response and the backend target to identify the corresponding namespace since multiple namespaces can be associated with a backend target. The OSA can maintain a bi-directional mapping between namespace identifiers and combinations of backend targets and logical containers.

At block 407, the OSA creates an abstracted response with the extracted data and the namespace identifier. For example, the OSA creates an abstracted response with the namespace identifier, the object identifier, an indication of success or failure, and retrieved data if the request was a read type of command. As previously mentioned, the OSA may convert or transform the object identifier used by the backend target into an object identifier used by the namespace. In some cases, the OSA may create multiple abstracted responses for retrieved data if too large for the communication mechanism used to communicate the response to the upstream component.

At block 409, the OSA returns the abstracted response to the upstream component. The OSA can determine the appropriate upstream component among multiple by leveraging the messaging mechanism between the OSA and the upstream component(s). If different communication mechanisms are used for different upstream components, then the OSA can maintain data that maps communication mechanisms to upstream components. The OSA can use this mapping data to determine an upstream component identifier and associate that with the communication to correctly route the abstracted response. In addition to ensuring that an abstracted response is sent to the correct upstream component, the OSA also ensures the response is associated with the correct requested command. A client/server communication mechanism can be implemented between the OSA and upstream components to track in-flight commands. This client/server communication mechanism can assign message identifiers to each command submitted to the OSA. The OSA can persist this message identifier as an additional attribute of the abstracted command that is eventually converted into a target protocol implementation and travels along with the converted command. The OSA can also use timestamps as proxy for the message identifier. When the OSA receives the abstracted command, the OSA can write a timestamp into the abstracted command and assign the message identifier to a combination of the timestamp, command type, and namespace identifier. Since a target protocol implementation will likely preserve the timestamp for various uses (e.g., quality of service analysis), the OSA timestamp will persist to the response and can be used to determine a message identifier.

Variations

As mentioned earlier, these example operations presume that the OSA has the capability to translate a target protocol response into an abstracted response. In some embodiments, the OSA instead modifies the response and communicates the modified response to another upstream component, for example an OSFS instance, for translation to an abstracted response. Although the OSA would communicate a response to another component for translation, the OSA uses the appropriate namespace object instance and backend target structure to indicate the appropriate namespace (e.g., file system instance identifier). The OSA can operate without a front facing OSFS or other upstream component that creates abstracted object commands. The OSA can include the program code to translate various client facing protocols (e.g., file-based protocols, object store protocols, etc.) into abstracted object commands.

The OSA can determine consistency capabilities of a backend target. The OSA can use the information about consistency capabilities to allow the OSA to offer or operate according to the backend target consistency capability and/or to satisfy consistency requests of a namespace client to facilitate tailoring of consistency level for a namespace. When the OSA establishes a connection with a backend target, the OSA can query (if not automatically received as part of connection establishment) the backend target for consistency capabilities (e.g., eventual consistency, weak consistency, strong consistency, etc.). The OSA can then consult this information to determine whether a requested consistency level can be satisfied for a namespace client. Instead of obtaining this information beforehand, the OSA can also query the backend target in response to detecting indication of a consistency level in an abstracted command or to detecting configuration related to quality of service. For example, the OSA can request a site-consistent level of a backend target when writing to a backend target (i.e., sending a write type of request/command to a backend target). With this request, the OSA is requesting that the backend target ensure the data being written is written to stable storage of the backend target before acknowledging the write. If a requested consistency level is not achieved, the backend target can report which consistency level was achieved to the OSA.

An OSA can also implement various policy driven data transformations to data traversing the OSA between clients and backend targets. The configuration data of a backend target and/or a namespace can include data management policies (e.g., compression, encryption, deduplication, etc.). This is loaded into the appropriate namespace object instance and/or backend target structure entry upon startup of the OSA or if a configuration change is detected. If a data management policy is detected by the OSA, then the OSA can load the corresponding data management module (e.g., a compression module, an encryption module, etc.). For backend targets with a data management policy, the OSA will apply the data management policy (i.e., invoke the data management policy module) prior to the target protocol implementation module. For example, the OSA will cause data to be stored into object storage to be compressed before being embedded into the target protocol implementation of a write type of command. The OSA will indicate ordering (or the ordering can be part of the configuration data) for one or more data management policies and the target protocol implementation to be applied.

The above example illustrations refer to size of data being written or size of an object being created to select from multiple custom implementations of a backend target protocol. However, the OSA may also choose from multiple backend targets based on attributes of the object to be created/written and/or status of the associated backend targets. For example, a namespace may be configured to associate it with multiple backend targets. The OSA can determine current status of the associated backend targets and then select one that satisfies any quality of service or service level agreement associated with a client of the object being created/written. The OSA could also/instead select from the associated backend targets based on consistency levels that can be achieved by the associated backend targets. In some cases, the OSA can write to multiple backend targets and remove the object from those that cannot achieve the requested consistency level.

The examples refer to an “object store adapter.”, or OSA. The object store adapter is a construct used to refer to implementation of functionality for adapting abstracted object commands for multiple namespaces to heterogeneous backend targets. This construct is utilized since numerous implementations are possible. An object store adapter may be referred to as a service, bridge, software stack, a particular component or components of a machine (e.g., a particular circuit card enclosed in a housing with other circuit cards/boards), a circuit card with circuitry configured and programmed with program code for the previously described functionality, etc. The term is used to efficiently explain content of the disclosure.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

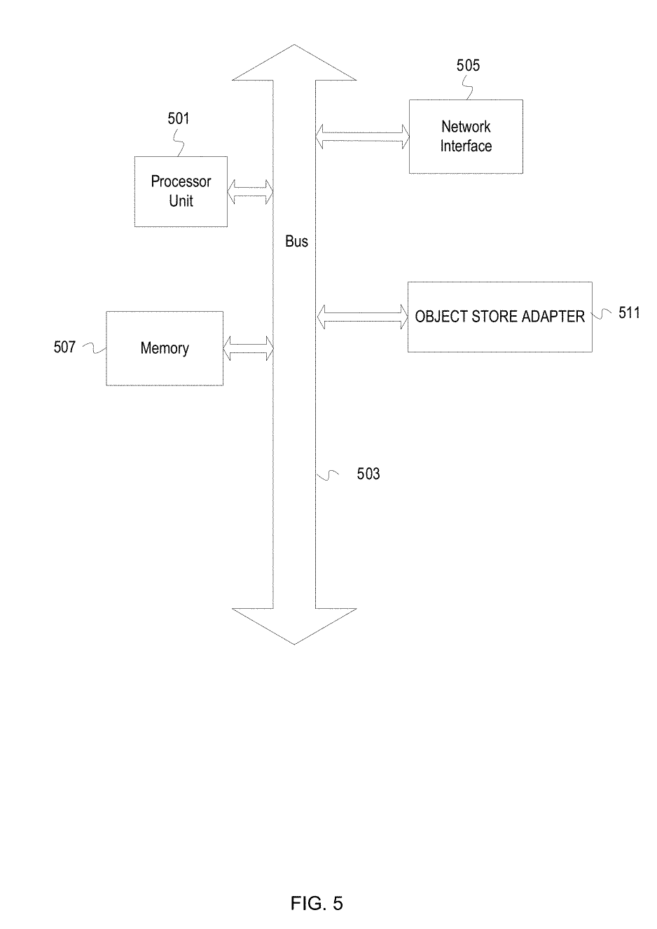

FIG. 5 depicts an example computer system with an object store adapter. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes an object store adapter 511. The object store adapter 511 operates as a bridge between various namespace instances (e.g., different file system instances) and a heterogeneous backend targets. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for adapting commands to any of a variety of heterogeneous backend targets as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining, from a plurality of file system object instances that represent a plurality of file system instances, a first file system object instance for a first file system instance identified in an abstracted object command instance after receipt of the abstracted object command instance, wherein the abstracted object command instance comprises an instance of an abstracted command defined for a file system command;
determining, with the first file system object instance, a first object store of a plurality of object stores that backs the first file system instance;
converting the abstracted object command instance to an implementation of the abstracted object command according to an object storage protocol specified for the first object store; and
submitting the implementation of the abstracted object command instance to the first object store.

2. The method of claim 1 further comprising:
determining that the abstracted object command is defined for a file system command after receipt of an instance of the file system command for the first file system instance; and
creating the instance of the abstracted object command defined for the file system command based, at least in part, on the instance of the file system command, wherein the abstracted object command instance is created with an identifier of the first file system instance.

3. The method of claim 1, wherein determining the first file system object instance for the first file system instance identified in the abstracted object command instance comprises using an identifier of the first file system instance to select the first file system object instance from a plurality of file system object instances.

4. The method of claim 3 further comprising determining the identifier of the first file system instance based, at least in part, on a name of the first file system instance indicated in an instance of a file system command instance, wherein the file system command instance was converted into the abstracted object command instance based, at least in part, on the abstracted object command being defined as an abstraction of the file system command.

5. The method of claim 1, wherein the first file system object instance comprises the identifier of the first file system instance, attributes of the first file system instance, indication of a file-based protocol of the first file system instance, and an identifier of the first object store.

6. The method of claim 1 further comprising:
determining, with the first file system object instance, an identifier of the first object store associated with the first file system instance identifier;
accessing a structure to determine the object store protocol specified for the first object store, wherein the structure indicates the plurality of object stores and indicates object store protocols of the plurality of object stores, wherein the accessing uses the identifier of the first object store.

7. The method of claim 1, wherein converting comprises:
determining that the abstracted object command corresponds to a plurality of implementations;
selecting the implementation from the plurality of implementations based, at least in part, on a size of data indicated by the abstracted object command.

8. The method of claim 1, wherein converting comprises using an identifier of the first object store instead of the identifier of the first file system instance in the implementation of the abstracted object command instance.

9. One or more non-transitory machine-readable media comprising program code for adapting an abstracted object command to any one of a plurality of protocol implementations for a plurality of backend targets, the program code to:
determine, from a plurality of namespace object instances that represent a plurality of namespaces, a first namespace object instance for a first namespace identified in an abstracted object command instance after receipt of the abstracted object command instance, wherein the abstracted object command instance comprises an instance of an abstracted command defined for a command defined by a data access protocol of the first namespace;
determine, with the first namespace object instance, a first backend target of a plurality of backend targets, wherein the plurality of backend targets implement a plurality of data access protocols;
convert the abstracted object command instance to an implementation of the abstracted object command according to a first data access protocol specified for the first backend target, wherein the program code to convert comprises program code to use an identifier of a logical container in the first backend target instead of the identifier of the first namespace in the implementation; and
submit the implementation of the abstracted object command instance to the first backend target.

10. The machine-readable media of claim 9, wherein the implementation comprises a set of one or more data access requests that correspond to the abstracted object command.

11. The machine-readable media of claim 9 further comprising program code to:
determine that the abstracted object command is defined for a first data access protocol command of the first namespace after receipt of an instance of the first data access protocol command for the first namespace; and
create the instance of the abstracted object command based, at least in part, on the instance of the first data access protocol command, wherein the abstracted object command instance is created with an identifier of the namespace.

12. The machine-readable media of claim 9, wherein determining the first namespace object instance for the first namespace identified in the abstracted object command instance comprises using an identifier of the first namespace to select the first namespace object instance from a plurality of namespace object instances.

13. The machine-readable media of claim 12 further comprising program code to determine the identifier of the first namespace based, at least in part, on a name of the first namespace indicated in an instance of a first data access protocol command instance, wherein the first data access protocol command instance was converted into the abstracted object command instance based, at least in part, on the abstracted object command being defined as an abstraction of the first data access protocol command.

14. The machine-readable media of claim 9, wherein the first namespace object instance comprises the identifier of the first namespace, attributes of the first namespace, indication of a data access protocol of the first namespace, and an identifier of the first backend target.

15. The machine-readable media of claim 9 further comprising program code to:
determine, with the first namespace object instance, an identifier of the first backend target associated with the first namespace identifier;
access a structure, with the identifier of the first backend target, to determine the first data access protocol specified for the first backend target, wherein the structure indicates the plurality of backend targets and indicates data access protocols of the plurality of backend targets.

16. The machine-readable media of claim 9, wherein the program code to convert comprises program code to:
determine that the abstracted object command corresponds to a plurality of implementations;
select the implementation from the plurality of implementations based, at least in part, on a size of data indicated by the abstracted object command.

17. The machine-readable media of claim 9, wherein the program code to convert comprises program code to use an identifier of the first backend target instead of the identifier of the first namespace in the implementation of the abstracted object command instance.

18. An apparatus comprising:
a processor unit; and
a machine-readable medium having program code executable by the processor unit to cause the apparatus to,
determine, from a plurality of namespace object instances that represent a plurality of namespaces, a first namespace object instance for a first namespace identified in an abstracted object command instance after receipt of the abstracted object command instance, wherein the abstracted object command instance comprises an instance of an abstracted command defined for a command defined by a data access protocol of the first namespace;
determine, with the first namespace object instance, a first backend target of a plurality of backend targets, wherein the plurality of backend targets implement a plurality of data access protocols;
convert the abstracted object command instance to an implementation of the abstracted object command according to a first data access protocol specified for the first backend target, wherein the program code to convert comprises program code to use an identifier of a logical container in the first backend target instead of the identifier of the first namespace in the implementation; and
submit the implementation of the abstracted object command instance to the first backend target.

19. The apparatus of claim 18, wherein the program code to convert comprises program code executable by the processor unit to cause the apparatus to:
determine that the abstracted object command corresponds to a plurality of implementations;
select the implementation from the plurality of implementations based, at least in part, on a size of data indicated by the abstracted object command.

20. The apparatus of claim 19, wherein the program code to convert comprises program code executable by the processor unit to cause the apparatus to use an identifier of the first backend target instead of the identifier of the first namespace in the implementation of the abstracted object command instance.
